(19) United States
(12) Patent Application Publication
(10) Pub. No.: US 2026/0331931 A1
(43) Pub. Date: Oct. 22, 2026

(54) BATTERY FAST CHARGING SYSTEM

(71) Applicant: CI CORPORATION PTY LTD, Queensland (AU)

(72) Inventor: Ahmed El Safty, Queensland (AU)

(21) Appl. No.: 19/486,208

(22) PCT Filed: May 21, 2024
(86) PCT No.: PCT/AU2024/050518

§ 371 Date: Nov. 20, 2025

(30) Foreign Application Priority Data
May 21, 2023 (AU) 2023901576

(51) Int. Cl. H02J 7/50; B60L 53/53; B60L 53/62; H02J 7/54; H02J 7/60; H02J 7/80

(52) U.S. Cl. CPC H02J 7/575; B60L 53/53; B60L 53/62; H02J 7/54; H02J 7/60; H02J 7/80; H02J 2207/20

(57) ABSTRACT

A battery fast charging system enables effective transitioning between series and parallel modes. The system comprises: at least a first and a second battery pack, each battery pack comprising multiple chemical cells; switches to establish a connection in series between the first battery pack and the second battery pack; switches to establish a connection in parallel between the first battery pack and the second battery pack; and a controller configured to detect an internal battery status of each battery pack by performing cell balancing, and temperature and voltage measurements. The controller, in response to a status of each battery pack, is further configured to transition between the connection in series between the first battery pack and the second battery pack and the connection in parallel between the first battery pack and the second battery pack.

### TECHNICAL FIELD

The invention relates to rechargeable power systems incorporating multiple batteries, battery clustering and ways to achieve faster charge rates.

### BACKGROUND OF THE INVENTION

A main impediment to truck fleet electrification is the time it takes to charge a large battery that is designed to achieve a long vehicle range.

Currently, there are ultra-fast charging stations on the market that can deliver 350 kW-1 MW of power, allowing Electric Vehicle (EV) users to charge their batteries at a faster rate than chargers that have a capacity that is a fraction of the abovementioned capacities.

A Battery Management System (BMS) will typically dictate the rate at which a battery can be charged, which is designed to ensure that a battery will last a long time and reduce the risk of thermal runaway, which could result in a fire or an explosion.

The state of health of batteries is directly related to the rate of charge and therefore a fast-charging unit must maintain a charge current that takes this into account.

Higher Voltage (HV) (circa 800V and above) EV powertrain designs and internal electrical vehicle architectures have much stricter requirements when compared to Medium Voltage (MV) (circa 400V and below) EVs. This is due to the necessity of greater clearances around connectors and wires, and the potential of the higher voltage arcing. Additionally, HV EV electrical and electronics components have higher isolation and creepage design requirements as well as higher voltage ratings—all these factors increase the component's cost. Components for MV range EVs are widely available and are currently mainstreamed for EV batteries.

With MV EV batteries, they cannot accept higher power ratings from the charger since the charging current becomes quite significant for an electrical car system. It is also important to consider that the EV battery bank itself dictates both the charging current and acceptable incoming power, and not the charger (therefore, the charger may not be reaching its maximum power output capability).

A higher charging current creates significant heat losses on cables (~I²*R) and internal battery resistance. To support such higher charging currents, a battery typically require a sophisticated cooling system, which is generally expensive to implement from a design and manufacturing perspective.

### OBJECT OF THE INVENTION

It is an object of the present invention to overcome and/or alleviate one or more of the disadvantages of the prior art or provide the consumer with a useful or commercial choice.

### SUMMARY OF THE INVENTION

According to some embodiments, the present invention provides systems and electric circuit topologies for charging electric or hybrid electric vehicles. The stored energy can be used for the propulsion of an electric vehicle. The invention relates to a mobile storage system that comprises several battery clusters which in turn consist of pairs of identical battery packs.

The electrical system of a battery energy storage system comprises a first (B1) and a second (B2) battery pack for storing electrical energy. In general, the storage system may have multiple numbers of packs that consist of a certain number of battery cells connected in series or parallel combinations to form a string of storage cells with the required total voltage. The battery packs are considered identical with the same type of cells. Two battery packs are electrically interconnected by using a switching control system and form a single cluster.

Within the electrical system, there exists a controller (104), which generates a switching control signal that the switching control system responds to. The controller is programmed to activate the switching control system through a specific number of switches, in accordance with the changeover matrix. By doing so, the battery packs B1 and B2 can be connected or disconnected from each other to form a series or parallel connection in relation to the DC positive and negative battery system bus (101).

The controller is designed to actuate by turning a specific combination of switches in such a way that battery storage modules can be connected in series to reach a high charging voltage, once reached the charging process can be initiated.

At the same time, the controller is programmed to activate by switching on or off a particular set of switches in a manner that allows for the battery storage packs to be connected in parallel, resulting in a lower system voltage when the battery storage system is linked to the powertrain of the vehicle.

The controller is designed to make a transition between a series-to-parallel mode in response to a certain threshold imbalance that may exist between the two interconnected battery packs. The electrical system includes a delay circuit (102) that provides an additional layer of safety features during switching operations and system transitions between the two series-to-parallel battery system modes.

Each battery pack within a single cluster has an individual battery management system with balancing capabilities.

The electrical system is equipped with a ballast resistor (100), and the controller (104) can react to a particular degree of imbalance between two battery packs by activating and deactivating the ballast resistor that links the two packs together. Once the pack balancing process is complete and negotiations with the charger (103) have been settled, the controller executes a specific switching transition to alter the charging mode of the system. Additionally, a technique is used to equalize the state of charge between the two distinct battery packs.

One aspect of the invention may be directed to another method for charging a vehicle battery. The method may involve a strategy and procedure that divides the vehicle battery into charging clusters, considering that the battery comprises N packs (where N is an even number). An additional aspect of the invention may pertain to the charging technique, whereby various battery clusters from the same vehicle can be charged from separate charging stations.

Another variation of the invention illustrated in FIG. 2 may offer a method for charging a vehicle. The process may feature a master controller (1) that oversees and modifies the current flow between the battery clusters (6) and the charging station during the charging procedure. The master controller retrieves data from the battery packs and delivers feedback to the charging station through communication protocols (2), which outline the necessary current levels that must be supplied to the battery packs to guarantee the automatic balancing of the state of charge and pack voltage.

The master controller is responsive to the threshold level of imbalance between two battery packs and provides control of switches (4) and (5).

In one aspect, although it need not be the only or the broadest aspect, the invention resides in a battery fast charging system, comprising:
at least a first and a second battery pack, each battery pack comprising multiple chemical cells;
switches to establish a connection in series between the first battery pack and the second battery pack;
switches to establish a connection in parallel between the first battery pack and the second battery pack; and
a controller configured to detect an internal battery status of each battery pack by performing cell balancing, and temperature and voltage measurements;
wherein the controller, in response to a status of each battery pack, is further configured to transition between the connection in series between the first battery pack and the second battery pack and the connection in parallel between the first battery pack and the second battery pack.

Preferably, balancing the first and second battery packs uses a ballast resistor that can be connected between the first and second battery packs.

Preferably, the controller controls the ballast resistor in response to a level of imbalance between the first and second battery packs.

Preferably, the switches include:
a first switch connected between a negative terminal of the first battery pack and a positive terminal of the second battery pack;
a second switch connected between a negative terminal of the first battery pack and a negative DC bus;
a third switch connected between the positive terminal of the second battery and a positive DC bus; and
a fourth switch connected between the positive DC bus and a load.

Preferably, the system further comprises a hardware delay circuit that provides safety features during system mode transitions between the connection in series and the connection in parallel.

Preferably, the system further comprises several switches that connect and disconnect two battery clusters and connect and disconnect to/from a charge point.

Preferably, the system further comprises a high-speed DC-DC charger and a master controller; wherein the master controller separates the system into battery clusters by disconnecting clustering contactors and connecting charge control contactors.

Preferably, the master controller monitors a battery state of each cluster.

Preferably, the master controller communicates with the DC-DC charger and provides feedback to the charger regarding a required charging current for a corresponding cluster.

Preferably, a switch is connected between a first battery cluster and a first charging device; another switch is located between a second battery cluster and a second charging point; another switch is located between positive terminals of the two clusters; and another switch is located between negative potentials of the two clusters.

Preferably, the all switches comprise high voltage contactors sufficient to carry a current required by a charging infrastructure.

According to another aspect, the invention resides in a method for balancing two battery packs, the method comprising:
balancing each battery pack at a cell level using a cell balancing circuit;
actuating a plurality of switches configured to connect the two battery packs in alternatively series and parallel modes;
isolating each battery pack and connecting each battery pack to a charging point; and
controlling a charge current depending on a battery system status.

### BRIEF DESCRIPTION OF THE DRAWINGS

FIG. 1 is a schematic illustrating the implementation of a single cluster where two batteries can form either a serial or parallel connection, according to some embodiments of the present invention.

FIG. 2 is a schematic illustrating an overview of a clustering approach for charging purposes in the case of two battery clusters, according to some embodiments of the present invention.

FIG. 3 is a flow diagram representing a battery clusters balancing algorithm, according to some embodiments of the present invention.

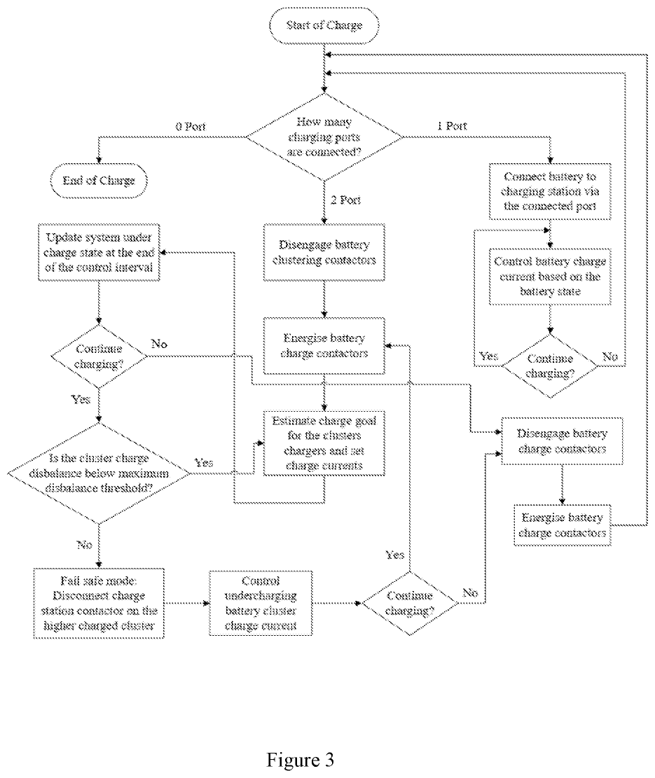

FIG. 4 illustrates equivalent circuits for cluster charging, according to some embodiments of the present invention.

### DETAILED DESCRIPTION OF EMBODIMENTS

Embodiments of the present invention provide electrical systems and methods for charging an electric vehicle or hybrid electric vehicle battery energy storage systems (BESS).

An electrical battery system includes a rechargeable battery energy storage system, controller and switching circuitry. The BESS includes first and second batteries that form a single charging cluster. The Battery Energy Storage System (BESS) can comprise multiple clusters that are capable of being linked or separated from the shared buses through switches.

The switches are also set up to connect or disconnect two batteries within the cluster to form either series or parallel battery connections. To enable fast-charging, the batteries are arranged in a series configuration, which results in a higher system voltage. Conversely, when the vehicle is in operation, the batteries are arranged in a parallel configuration. Each battery pack possesses its own balancing capabilities.

The controller is configured to measure the state of the charge of the single battery pack as well as the charge difference between the two packs. The objective of the controller is to reduce the difference of the state of charge between the two battery packs in preparation for a parallel connection. The controller connects to the balancing resistor to balance the state of charge/voltage of the two batteries.

In addition, the controller supplies necessary data and engages in discussions with the charging station pertaining to the battery's state of charge (SOC) and the optimal charging current that should be delivered to the battery.

The battery clusters can be charged from the different charging stations. The master controller provides coordination of the charging process between clusters to ensure battery capacity/voltage balancing between them is in place.

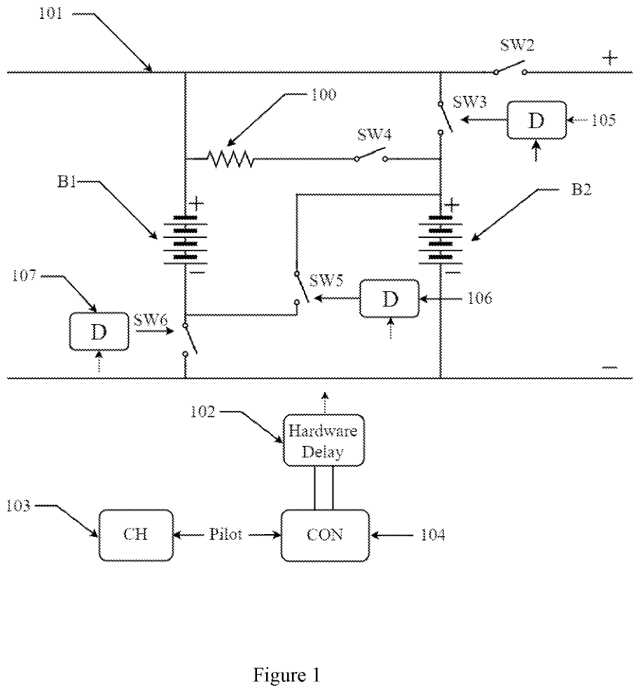

FIG. 1 shows an electrical system of a battery energy storage system comprising: first (B1) and second (B2) battery packs, a controller (104), a delay unit (102), several switches, and a ballast resistor (100). By using a specific number of switches, the battery packs (B1) and (B2) can be connected or disconnected from each other to form a series or parallel connection with respect to the DC positive and negative battery system bus (101). Each battery pack has an individual battery management system with balancing capabilities.

To ensure that the system can exist in only one conclusive state at any given time, an extra level of safety features is provided by a hardware delay circuit (102) during the switching process between different charging system modes. In more detail, it is a “break before make” switch arrangement and is provided by hardware implementation.

The controller (104) can alternate between two distinct system charging modes by activating and deactivating a particular combination of switches. Additionally, the controller (104) can address a particular degree of imbalance between two battery packs by turning on and off a ballast resistor (100). Once the pack balancing process is finished and negotiations with the charger (103) have been completed, the controller performs a designated switching transition to modify the system mode.

The controller runs a state machine or real operating system with functional safety capabilities, monitoring voltages and temperatures of the battery cells. The controller will also be able to measure the total current, voltage, and other parameters of each battery pack. When the system is operating in “low voltage” mode, the two battery packs are connected in parallel. In this case, the switches SW2, SW3 and SW6 are closed. When the charger sends a pilot signal to the controller, the controller negotiates with the charger the power and the required charging current to supply to the battery packs.

Once the negotiation process between the controller and charger is complete the controller opens switches SW2, SW3, and SW6 while closing switches SW2 and SW5. As a result, the battery is configured as a high-voltage battery system for charging, with two batteries connected in series. The system with higher voltage can be charged with a smaller current, reducing loss on cables and high-current infrastructure.

In each battery pack the controller balances cells close to charging completion before opening SW5.

To respond to certain levels of voltage and charging capacity imbalance status in the two battery packs, the controller connects a ballast resistor using SW4 and SW6 to balance the energy.

When the certain level of voltage imbalance or state of charge between two battery packs is below a certain threshold, the controller opens SW4 and closes SW2 and SW3, making two battery packs in parallel and presenting a normal low voltage mode for powertrain operation. Hardware delay (102) presenting (105), (106) and (107) systems provide an additional layer of safety during switching between the charging modes.

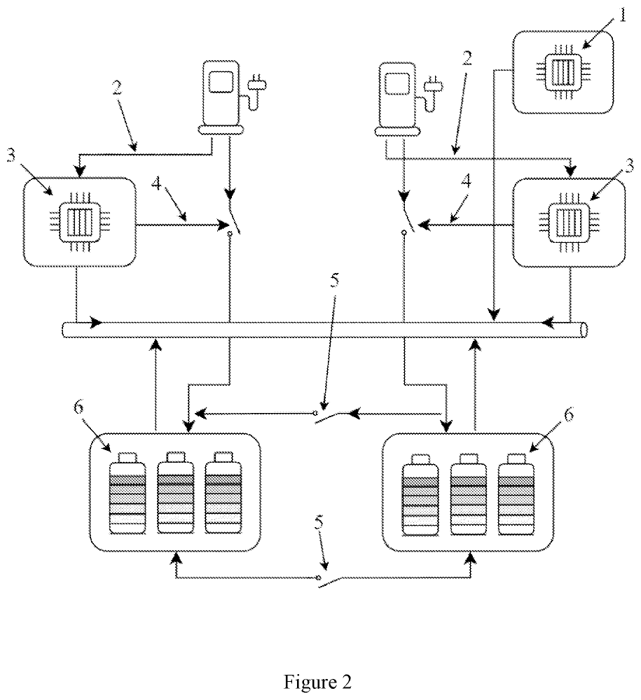

FIG. 2 shows the battery clustering for charging purposes in the case of two battery clusters.

An aspect of the invention includes a battery cluster, which is defined as an electrical system consisting of two battery packs. Charging of battery clusters from the same vehicle can be carried out at different charging stations with the coordination of the master controller to guarantee cluster balancing. When both charging sockets are in use during the charging process, the master controller divides the battery into clusters by separating the battery clustering contactors 1 and 2. Each cluster is then connected to its respective charging port through charging control contactors 1 and 2, as described earlier in this document.

The master controller actively monitors the battery state of the charge/voltage of each cluster and adjusts the charging current to ensure that all battery clusters are equally charged.

After the charging is complete, the charging station contactors 1 and 2 are opened, and the battery clusters are reconnected to ensure there is no imbalance between them.

This battery clustering solution can be scaled for multiple clusters, but the system complexity will increase accordingly. A crucial aspect of this solution is the battery balancing algorithm, which ensures that the clusters remain balanced and prevents the risk of high-current transitional processes during the reconnection of separated clusters.

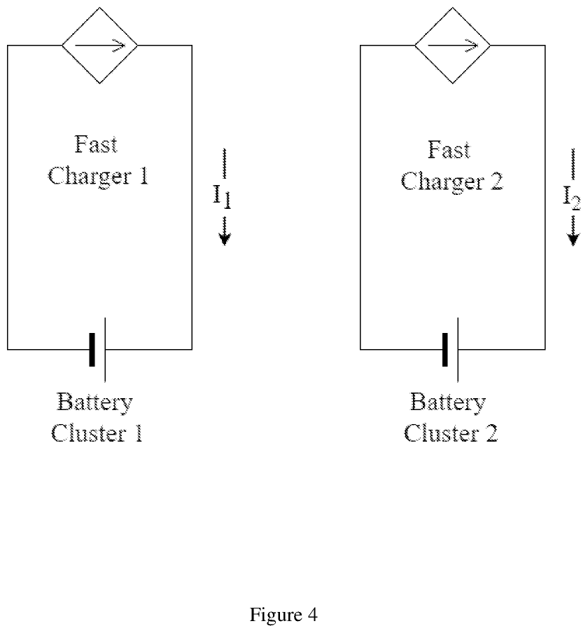

FIG. 4 below represents the charging equivalent circuit diagrams for the clustered charging case.

The batteries begin with the same level of charge, where V_{batt}=f(Q_{batt}). So, in other words, the voltages on the batteries are the same, which reflects the same charge level.

Charging the system begins with nominal charge current estimating voltages on the battery clusters and charging currents, which are the same for the initial state (defined as (V_{batt1} V_{batt2} I_{charge1} I_{charge2})).

At the end of the control interval (~50 ms) an update of the charge state is performed, based on battery voltages discrepancy (which means the difference in the charge level of the battery clusters) a charge current is requested from the battery charger to ensure the required charge discrepancy is mitigated on the next controlling step.

The residual current adjustment can be calculated as ΔI=(u(V_{batt1})−u(V_{batt2}))·Δt, where ΔI—current adjustment residual, u—reverse function of f, V_{batt}—voltages on the respective battery clusters, and Δt—control interval.

The control goal will be achieved by using Extended Kalman Filter (EKF) approach for all the control cycles in clustering mode.

If the battery cluster voltages surpass the secure reconnection threshold during a system malfunction, the system will enter a fail-safe mode. During this mode, charging will stop for the higher-charged cluster, while charging will continue for the lower-charged battery cluster.

The system will exit the fail-safe mode and resume charging according to the algorithm described earlier once the voltage falls within the safe range.

The proposed method in this application is a combination of the methods described above, which is dependent on the charging infrastructure's capabilities. If the charging infrastructure supports high voltage charging (e.g., 800V) for a specific cluster connected to the corresponding charging port, the batteries comprising the selected clusters can be connected in series to reduce charging time. In this case, the system must ensure the balanced charging of the clustered battery to achieve maximum charging performance. By using a combination of methods for all clusters, an optimal charging performance can be achieved.

In this patent specification, adjectives such as first and second, left and right, above and below, top and bottom, upper and lower, front and back, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

The above description of various embodiments of the present invention is provided for purposes of description to one of ordinary skill in the related art. It is not intended to be exhaustive or to limit the invention to a single disclosed embodiment. Numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

1. A battery fast charging system, comprising:
at least a first and a second battery pack, each battery pack comprising multiple chemical cells;
switches to establish a connection in series between the first battery pack and the second battery pack;
switches to establish a connection in parallel between the first battery pack and the second battery pack; and
a controller configured to detect an internal battery status of each battery pack by performing cell balancing, and temperature and voltage measurements;
wherein the controller, in response to a status of each battery pack, is further configured to transition between the connection in series between the first battery pack and the second battery pack and the connection in parallel between the first battery pack and the second battery pack.

2. The battery fast charging system of claim 1, wherein balancing the first and second battery packs uses a ballast resistor that can be connected between the first and second battery packs.

3. The battery fast charging system of claim 2, wherein the controller controls the ballast resistor in response to a level of imbalance between the first and second battery packs.

4. The battery fast charging system of claim 1, wherein the switches include:
a first switch connected between a negative terminal of the first battery pack and a positive terminal of the second battery pack;
a second switch connected between a negative terminal of the first battery pack and a negative DC bus;
a third switch connected between the positive terminal of the second battery and a positive DC bus; and
a fourth switch connected between the positive DC bus and a load.

5. The battery fast charging system of claim 1, further comprising a hardware delay circuit that provides safety features during system mode transitions between the connection in series and the connection in parallel.

6. The battery fast charging system of claim 5, further comprising several switches that connect and disconnect two battery clusters and connect and disconnect to/from a charge point.

7. The battery fast charging system of claim 1, further comprising a high-speed DC-DC charger and a master controller; wherein the master controller separates the system into battery clusters by disconnecting clustering contactors and connecting charge control contactors.

8. The battery fast charging system of claim 7, wherein the master controller monitors a battery state of each cluster.

9. The battery fast charging system of claim 7, wherein the master controller communicates with the DC-DC charger and provides feedback to the charger regarding a required charging current for a corresponding cluster.

10. The battery fast charging system of claim 9, wherein a switch is connected between a first battery cluster and a first charging device; another switch is located between a second battery cluster and a second charging point; another switch is located between positive terminals of the two clusters; and another switch is located between negative potentials of the two clusters.

11. The battery fast charging system of claim 1, where all switches comprise high voltage contactors sufficient to carry a current required by a charging infrastructure.

12. A method for balancing two battery packs, the method comprising:
balancing each battery pack at a cell level using a cell balancing circuit,
actuating a plurality of switches configured to connect the two battery packs in alternatively series and parallel modes;
isolating each battery pack and connecting each battery pack to a charging point; and
controlling a charge current depending on a battery system status.
